(19) United States
(12) Patent Application Publication
(10) Pub. No.: US 2010/0182365 A1
(43) Pub. Date: Jul. 22, 2010

(54) Inkjet printing apparatus

(75) Inventor: Yoshihisa Kayanaka, Ama-gun (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya (JP)

(21) Appl. No.: 12/591,297

(22) Filed: Nov. 16, 2009

(30) Foreign Application Priority Data
Jan. 19, 2009 (JP) 2009-008509

(51) Int. Cl. B41J 29/38

(52) U.S. Cl. 347/14

(57) ABSTRACT

An inkjet printing apparatus is provided. The inkjet printing apparatus includes a recording head, which ejects ink onto s recording medium, an ink cartridge, which contains the ink therein, an ink cartridge storage to store the ink cartridge, an ink conveyer tube, which connects the recording head and the ink cartridge to convey the ink, a releasing system, arranged in the ink conveyer tube to switch an open state and a closed state, a release controller, which controls switching of the releasing system, and a judging system, which judges as to whether the ink in the ink conveyer tube is capable of being withdrawn in the ink cartridge. The release controller switches the releasing system in the open state to be in the closed state when the judging system judges that the ink is incapable of being withdrawn in the ink cartridge.

### CROSS REFERENCE TO RELATED APPLICATION

This application claims priority from Japanese Patent Application No. 2009-008509, filed on Jan. 19, 2009, the entire subject matter of which is incorporated herein by reference.

### BACKGROUND

1. Technical Field

An aspect of the present invention relates to an inkjet printing apparatus, specifically to an inkjet printing apparatus configured to collect ink from an inkjet head and an ink tube and to store the ink in an ink cartridge.

2. Related Art

Conventionally, an inkjet printer, which is equipped with a means to collect the ink adhered to the inkjet head and remaining in the ink tube therefrom and a means to store store the collected ink in the ink cartridge, has been known.

For example, an inkjet printer having a cleaning mechanism to clean an ink conveyer path, which is between an ink supplier tube and a sub tank, is known. The ink remaining in the ink conveyer path is collected and stored in the ink cartridge. The ink cartridge is settled in a lower position with respect to the sub tank in a direction of gravity force; therefore, when an ink supplier valve provided in the ink conveyer path opens, the ink flows back from the sub tank to the ink cartridge. Thus, the reversed ink is collected and stored in the ink cartridge. Thereafter, by an operator, the ink cartridge can be manually replaced with a cleaner cartridge. Cleaner liquid prepared in the cleaner cartridge is drawn in the ink conveyer path, and accordingly, the ink conveyer path is cleaned.

### SUMMARY

However, in the inkjet printer configured as above, the operator may, for example, accidentally remove the ink cartridge from the inkjet printer during the ink-collecting operation. Therefore, the path for the reversed ink is disconnected, and the ink may flow out of the ink tube and leak in and out of the inkjet printer.

In view of the above drawbacks, the present invention is advantageous in that an inkjet printing apparatus, in which leakage of the ink out of the ink tube upon removal of the ink cartridge can be prevented, is provided.

According to an aspect of the present invention, an inkjet printing apparatus to form an image on a recording medium according to print data representing the image, is provided. The inkjet printing apparatus includes a recording head, which ejects ink onto the recording medium, an ink cartridge, which contains the ink therein, an ink cartridge storage to store the ink cartridge, an ink conveyer tube, which connects the recording head and the ink cartridge to convey the ink, a releasing system, which is arranged in the ink. conveyer tube to switch an open state in which air flow in the ink conveyer tube is released and a closed state in which the air flow in the ink conveyer tube is shut down, a release controller, which controls switching of the releasing system, and a judging system, which judges as to whether the ink in the ink conveyer tube is capable of being withdrawn in the ink cartridge. The release controller switches the releasing system in the open state to be in the closed state when the judging system judges that the ink is incapable of being withdrawn in the ink cartridge.

### BRIEF DESCRIPTION OF THE ACCOMPANYING DRAWINGS

FIG. 1 is a plane view of an inkjet printer 1 according to an embodiment of the present invention.

FIG. 2 is a front view of the inkjet printer 1 according to the embodiment of the present invention.

FIG. 3 is an enlarged partial view of the inkjet printer 1 according to the embodiment of the present invention.

FIG. 4 is a front view of a first recording head 21 and a release valve 44 in the inkjet printer 1 according to the embodiment of the present invention.

FIGS. 5A and 5B illustrate an ink collecting operation of the release valve 44 in the inkjet printer 1 according to the embodiment of the present invention.

FIG. 6 is a block diagram to illustrate an electric configuration of the inkjet printer 1 according to the embodiment of the present invention.

FIGS. 7A and 7B are diagrams to illustrate an operation indicator panel 28 in the inkjet printer 1 according to the embodiment of the present invention.

FIG. 8 is a flowchart to illustrate a main flow of the operation of the inkjet printer 1 according to the embodiment of the present invention.

FIG. 9 is a flowchart to illustrate an ink withdrawal operation to be executed in the inkjet printer 1 according to the embodiment of the present invention.

### DETAILED DESCRIPTION

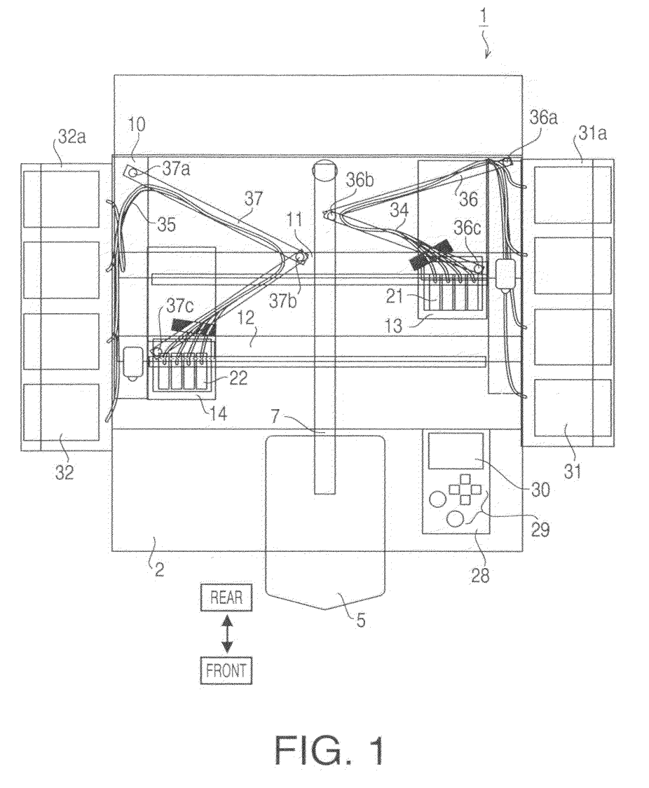

Hereinafter, an embodiment according to an aspect of the present invention will be described with reference to the accompanying drawings. Firstly, an inkjet printer 1 according to the present embodiment will be described with reference to FIGS. 1 though 7. The inkjet printer 1 is an inkjet printer for printing an image on a piece of fabric in an inkjet method.

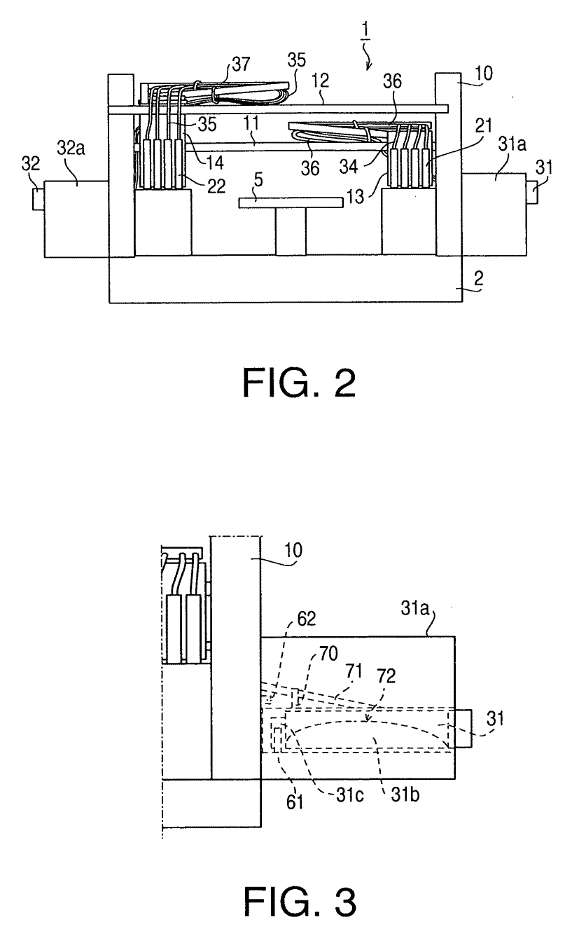

The inkjet printer 1 in the present embodiment is a known inkjet printer having first recording heads 21 and second recording heads 22 to form an image on a recording medium in inks ejected from nozzle surfaces of the first and the second recording heads 21, 22 according to image data. In the inkjet printer 1, a piece of fabric can be used as a recording medium, and the piece of fabric may be, for example, a T-shirt. As shown in FIGS. 1 and 2, the inkjet printer 1 is provided with a flat base plate 2 at a bottom and a chassis 10 to cover the entire body of the inkjet printer 1.

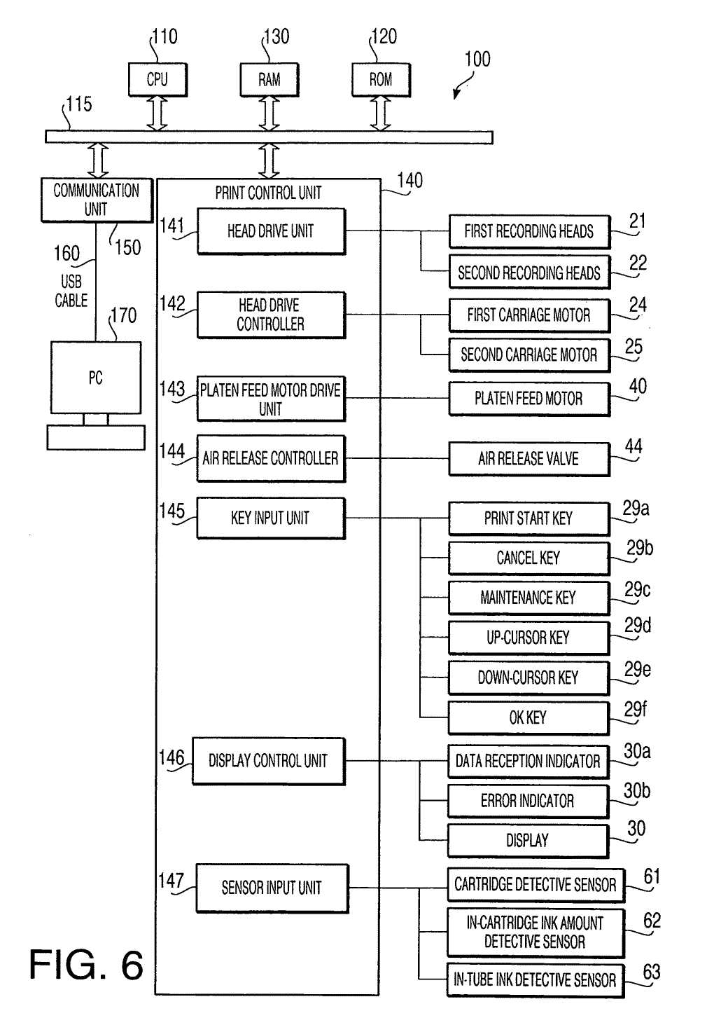

The first recording heads 21 are mounted on a carriage 13, which is reciprocated in a right-and-left direction in FIG. 1 along a guide rail 11. In the vicinity of a right-hand end of the guide rail 11, a first carriage motor 24 (FIG. 6) to carry the first inkjet heads 21 is provided. Further, a pulley (not shown) is provided in the vicinity of a left-hand end of the guide rail 11, and a carriage belt (not shown) is drawn between the first carriage motor 24 and the pulley. The carriage belt is fixed to a rear side of the carriage 13. The carriage 13 is slidably connected to the guide rail 11 and reciprocated along the guide rail 11 in the right-and-left direction (i.e., the main scanning direction) when the first carriage motor 24 is activated. At one of the right-hand end and the left-hand end of the reciprocative range of the carriage 13, a maintenance mechanism (not shown) such as a capping unit, a wipe unit, and a purge unit for the first recording heads 21 is provided.

A first ink cartridge container 31a is provided on the right-hand end of the chassis 10. The first ink cartridge container 31a has housing portions to house four first ink cartridges 31, which contain opaque white ink therein.

As shown in FIG. 3, each of the housing portions formed in the first ink cartridge container 31a is provided with a cartridge detective sensor 61. In this embodiment, optical sensors are used as the cartridge detective sensors 61.

On the upper surface of the housing portions, supporting members 70, which have squared U-shaped forms, in a lateral view, are provided. The supporting member 70 supports a rod-like ink amount detecting member 71 to be swingable about the supporting member 70 itself. The ink amount detecting member 71 is placed above the first ink cartridge 31 and provided with a detecting portion 72, which is made of resin and substantially triangular-shaped, at the right end.

The first ink cartridge container 31a is provided with an in-cartridge ink amount detective sensor 62 for each of the housing portion. The in-cartridge ink amount detective sensor 62 is located below the left end of the ink amount detecting member 71. In this embodiment, optical sensors are used as the in-cartridge ink amount detective sensors 62.

The triangular portion of the detecting portion 72 is configured to face downward and intrude in the first ink cartridge 31 through a hole formed substantially in a center of an upper wall of the first ink cartridge 31, and contact an ink pack 3 lb settled in the first ink cartridge 31. Due to a weight balance, the ink amount detecting member 71 is held by the supporting member 70 to be inclined to have the detecting portion 72 at the right-hand end in a lower position and the left-hand end in a higher position (see FIG. 3) in normal state. The inclination of the ink amount detecting member 71 changes according to the amount of the ink contained in the ink pack 31b.

The first ink cartridges 31 are connected to each of the first recording heads 21 by first ink conveyer tubes 34. In a printing operation, the white ink stored in the first ink cartridges 31 are conveyed to each channel of the first recording heads 21 via the first ink conveyer tubes 34.

The first ink conveyer tubes 34 are transparent and flexible tubes. The first ink conveyer tubes 34 to supply the ink to the first recording heads 21 are moved along with the first recording heads 21 when the carriage 13 with the first recording heads 21 is reciprocated in the main scanning direction between the right side end and the left side end of the guide rail 11. Therefore, the first ink conveyer tubes 34 are formed to be longer than a length of the guide rail 11. The inkjet printer 1 is equipped with a first arm 36 so that, when the carriage 13 is moved, the first ink conveyer tubes 34 can smoothly move to follow the carriage 13.

The first arm 36 includes a rear portion, which is a thin and elongated plate rotatable about a supporting point 36a, and a supporting point 36b is provided at an end of the rear portion. The first arm 36 further includes a front portion, which is a thin and elongated plate rotatable about the supporting point 36b and is coupled to the carriage 13 at a supporting point 36c.

The inkjet printer 1 according to the embodiment is equipped with a guide rail 12, which is arranged in parallel with the guide rail 11, to guide a carriage 14 with a second recording head 22 being mounted. As shown in FIG. 2, the guide rail 12 is arranged in a position higher than the guide rail 11.

In the vicinity of a left-hand end of the guide rail 12, a second carriage motor 25 (FIG. 6) is provided, and in the vicinity of the right-hand end of the guide rail 12, a pulley (not shown) is provided. Further, a carriage belt (not shown) is drawn between the second carriage motor 25 and the pulley. The carriage belt is fixed to the carriage 14 so that the carriage 14 is reciprocated along the guide rail 12 in the left-and-right direction (i.e., the main scanning direction) when the second carriage motor 25 is activated. At one of the right-hand end and the left-hand end of the reciprocative range of the carriage 14, a maintenance mechanism (not shown) such as a capping unit, a wipe unit, and a purge unit for the second recording heads 22 is provided.

A second ink cartridge container 32a is provided on the left-hand end of the chassis 10. The second ink cartridge container 32a has housing portions to house each of four second ink cartridges 32, which contains CMYK (cyan, magenta, yellow, and black) colored inks respectively therein. The second ink cartridges 32 are connected to each of the second recording heads 22 by second ink conveyer tubes 35 so that the CMYK colored inks stored in the second ink cartridges 32 are conveyed to each channel of the second recording heads 22.

The second ink conveyer tubes 35 are flexible tubes. The CMYK colored inks are supplied to the second recording heads 22 during a printing operation. The second ink conveyer tubes 35 to supply the ink to the second recording heads 22 are moved along with second recording heads 22 when the carriage 14 with the second recording heads 22 is reciprocated in the main scanning direction between the right side end and the left side end of the guide rail 12. Therefore, the second ink conveyer tubes 35 are formed to be longer than a length of the guide rail 12. The inkjet printer 1 is equipped with a second arm 37 so that, when the carriage 14 is moved, the second ink conveyer tubes 35 can smoothly move to follow the carriage 14.

The second arm 37 includes a rear portion, which is a thin and elongated plate, rotatable about a supporting point 37a, and a supporting point 37b is provided at an end of the rear portion. The second arm 37 further includes a front portion, which is a thin and elongated plate, rotatable about the supporting point 37b and is coupled to the carriage 14 at a supporting point 37c.

It is to be noted that, in the present embodiment, the main scanning direction of the first recording heads 21 and the second recording heads 22 (i.e., left-and right direction in FIG. 1) indicates the right-and-left direction of the inkjet printer 1.

The flat base plate 2 of the inkjet printer 1 is provided with a platen feed unit 7 to move a platen 5 in the front-and-rear direction. The upper side and the lower side of the inkjet printer 1 as shown in FIG. 1 correspond to the frontward and rearward of the inkjet printer 1, respectively. The platen feed unit 7 includes a guide rail (not shown) and a platen feed motor 40 (FIG. 6) being a stepping motor arranged at a rear end portion (i.e., upper end in FIG. 1) of the guide rail. When the platen feed motor 40 is activated, the platen 5 is reciprocated along the guide rail in the up-and-down direction in FIG. 1.

The platen 5 is a substantially rectangular-shaped flat plate with a shorter side facing an operator excurved. The recording medium (e.g., a T-shirt) is placed in a printable posture in the inkjet printer 1. The inkjet printer 1 may have a plurality of sizes of platen 5, which can be selected according to, for example, sizes and shapes of the recording media.

As shown in FIG. 1, at right-hand front of the inkjet printer 1 is provided an operation panel 28, through which the operator inputs an instruction for the inkjet printer 1. The operation panel 28 includes print buttons 29 and a display 30 being a LCD (liquid crystal display).

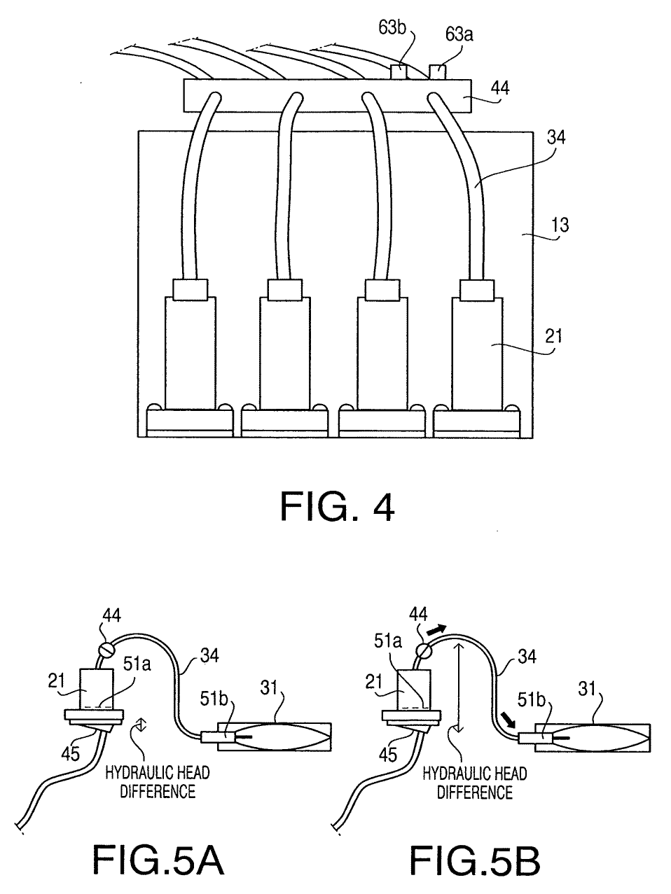

Next, a fluid releasing mechanism according to the present embodiment will be described with reference to FIG. 4. The inkjet printer 1 in the present embodiment is equipped with an air release valve 44, which releases and shuts down air flow in the first ink conveyer tubes 34. As has been mentioned above, the first ink conveyer tubes 34 connect the first ink cartridges 31 and the channels of the first recording heads 21. The air release valve 44 is an electromagnetic valve, which is switched from an open position and a closed position, and vice versa, to release and shut down the air flow in between the first recording heads 21 and the first ink cartridges 31 in the first ink conveyer tubes 34, according to electric signals. When the air release valve 44 is opened to release the air flow in the first ink conveyer tubes 34 with the first recording heads 21 being covered with caps 45 (see FIG. 5), the ink remaining in the first ink conveyer tubes 34 is withdrawn in the first ink cartridges 31.

As shown in FIG. 5A, when the caps 45 cover the nozzle surfaces of the first recording heads 21, and the air release valve 44 is switched to shut down the air flow in the first ink conveyer tubes 34, a hydraulic head difference between a level of the nozzle surfaces of the first recording heads 21 and an ink supplying level (i.e., vertical positions of the first ink cartridges 31) is substantially small so that the ink remaining in the first ink conveyer tubes 34 is not withdrawn in the first ink cartridges 31.

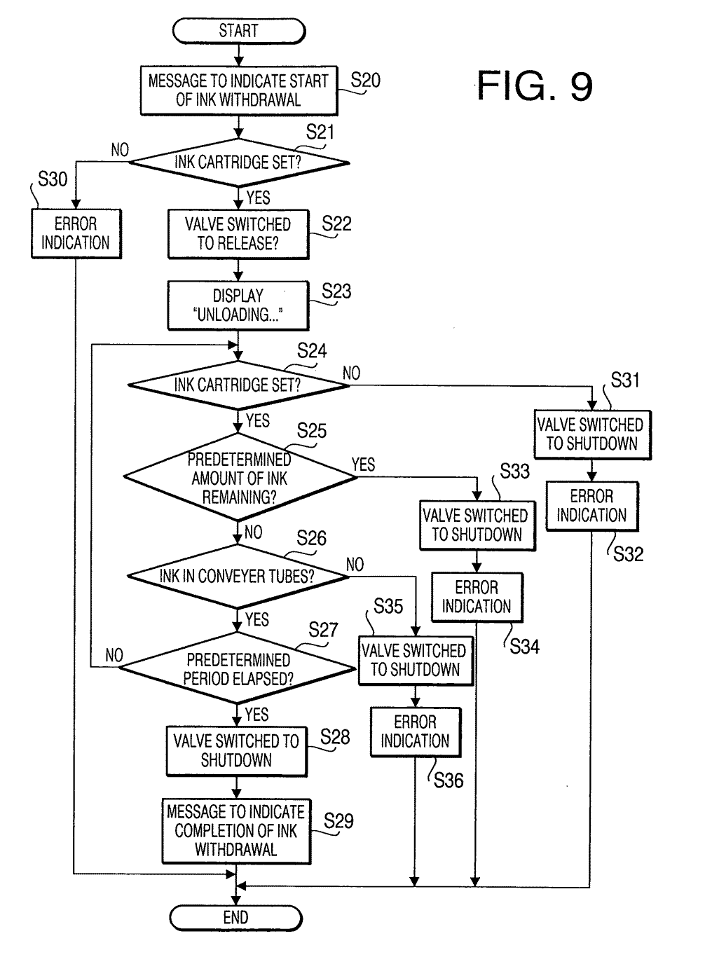

However, as shown in FIG. 5B, when the caps 45 cover the nozzle surfaces of the first recording heads 21, and the air release valve 44 is switched to release the air flow in the first ink conveyer tubes 34, the hydraulic head difference between a level of the air release valve 44 and the ink supplying level of the first ink cartridges 31 is substantially large so that the ink remaining in the first ink conveyer tubes 34 is withdrawn in the first ink cartridges 31. The ink reloading process will be described later in detail with reference to FIG. 9.

It is to be noted in the present embodiment that the first ink cartridges 31 are provided with filters 51b, and the first recording heads 21 are provided with filters 51a at positions indicated by dotted lines in FIGS. 5A and 5B. These filters 51a, 51b serve to catch obstacles flowing in the ink when the ink is collected.

As shown in FIG. 4, the air release valve 44 is provided with in-tube ink detective sensors 63 to detect presence of ink in the first ink conveyer tubes 34. In the present embodiment, the in-tube ink detective sensors 63 are optical sensors.

The in-tube ink detective sensor 63 includes a photo-emitting element 63a and a photo-sensitive element 63b with the first ink conveyer tube 34 intervening therebetween. The photo-emitting element 63a and the photo-sensitive element 63b being a pair is provided to each of the first ink conveyer tubes 34, although solely the rightmost pair is shown in FIG. 4, and the other three pairs are omitted for simplicity of explanation.

Next, referring to FIG. 6, an electrical configuration of the inkjet printer 1 will be described. As shown in FIG. 6, the inkjet printer 1 is provided with a control unit 100, and the control unit 100 includes a CPU 110 that controls the entire operation in the inkjet printer 1. The CPU 110 is connected with a ROM 120, a RAM 130 through a bus 115. The ROM 120 stores various controlling programs to be executed in the CPU 110. The RAM 130 temporarily stores data concerning the operations in the inkjet printer 1.

The CPU 110 is further connected with a communication unit 150 and with a PC (personal computer) 170 through a communication cable 160. Furthermore, the CPU 110 is connected with a print control unit 140 to control printing operations in the inkjet printer 1 through the bus 115.

The print control unit 140 includes a head controller 141, a head drive controller 142, a platen feed motor controller 143, an air release controller 144, a key input unit 145, the display control unit 146, and a sensor input unit 147.

The head controller 141 drives piezoelectric actuators for each of the channels in the first recording heads 21 and the second recording heads 22. The head drive controller 142 activates the first carriage motor 24 and the second carriage motor 25, and the platen feed motor controller 143 activates the platen feed motor 40. Further, the air release controller 144 controls switching of the air release valve 44.

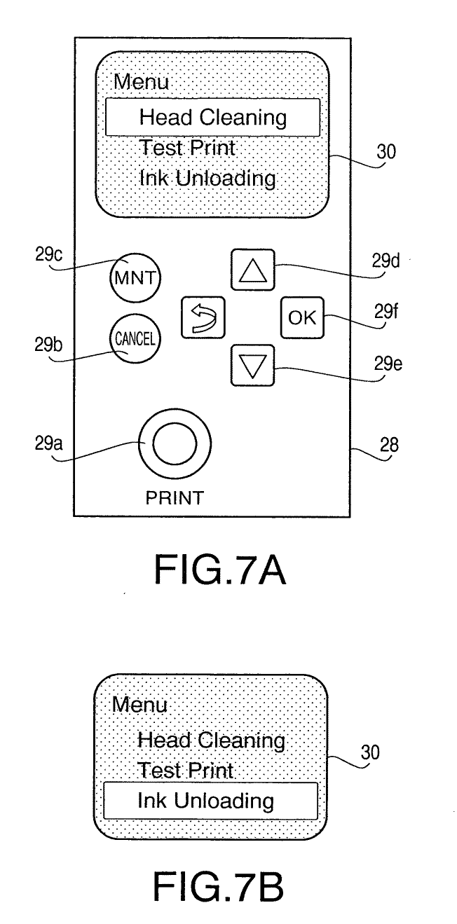

The key input unit 145 receives signals entered through a print start key 29a, a cancel key 29b, a maintenance key 29c, a cursor (up) key 29d, a cursor (down) key 29e, and an OK key 29f. The keys 29a-29f are provided in the operation panel 28 (see FIG. 7A). The operation panel 28 further includes a data reception indicator 30a, an error indicator 30b, and a display 30, which are controlled by the display control unit 146.

When the maintenance key 29c is pressed by the operator, the display 30 shows a menu screen (see FIG. 7A), on which menu options “Head Cleaning,” “Test Print,” and “Ink Unloading” are displayed. When the menu options are displayed, a background of an option being currently selected (i.e., “Head Cleaning” in FIG. 7A) is inverted. An option to be selected can be specified by up and down motions of a cursor, which can be shifted by the cursor (up) key 29d and the cursor (down) key 29e. Thus, when the cursor (down) key 29e is pressed twice from the position shown in FIG. 7A, the display 30 shows the option “Ink Unloading” inverted as shown in FIG. 7B. At this time, if the option “Ink Unloading” is selected with the OK key 29f, the ink withdrawal operation is started.

The sensor input unit 147 receives signals provided from the cartridge detective sensors 61, the in-cartridge ink amount detective sensors 62, and the in-tube ink detective sensors 63.

The cartridge detective sensor 61 includes a photo-emitter and a photo-receiver. When the first ink cartridge 31 is set in the first ink cartridge container 31a, a light blocker 31c provided to the first ink cartridge 31 is interposed between the photo-emitter and the photo-receiver to block the light from the photo-emitter. Thus, presence of the first ink cartridge 31 in the housing portion of the first ink cartridge container 31a is detected.

The in-cartridge ink amount detective sensor 62 has a photo-emitter (not shown) and a photo-receiver (not shown). When the ink is withdrawn into the ink pack 31b and a volume of the ink in the ink pack 31b increases, the ink pack 31b is inflated to lift up the detecting portion 72 at the right-hand end of the ink amount detecting member 71. Accordingly, the ink amount detecting member 71 swings about the supporting member 70, and the left-hand end of the ink amount detecting member 71 is lowered. Further, when the ink pack 31b is filled with the withdrawn ink, the left-hand end of the ink amount detecting member 71 is further lowered and interposed between the photo-emitter and the photo-receiver of the in-cartridge ink amount detective sensor 62 to block the light emitted from the photo-emitter. Accordingly, the ink being full in the ink pack 31b is detected.

The in-tube ink detective sensor 63, as mentioned above, includes the photo-emitting element 63a and the photo-sensitive element 63b. When substantially no ink remains in the first ink conveyer tube 34, the light from the photo-emitting element 63a transmits through the transparent first ink conveyer tube 34 and can be received by the photo-sensitive element 63b without being blocked by the opaque white ink. On the other hand, when the ink remains in the first ink conveyer tube 34, the light from the photo-emitting element 63a is blocked by the opaque white ink and cannot be received by the photo-sensitive element 63b. Therefore, in the present embodiment, presence of the ink remaining in the first ink conveyer tube 34 can be detected on bases of the signals provided by the photo-sensitive element 63b.

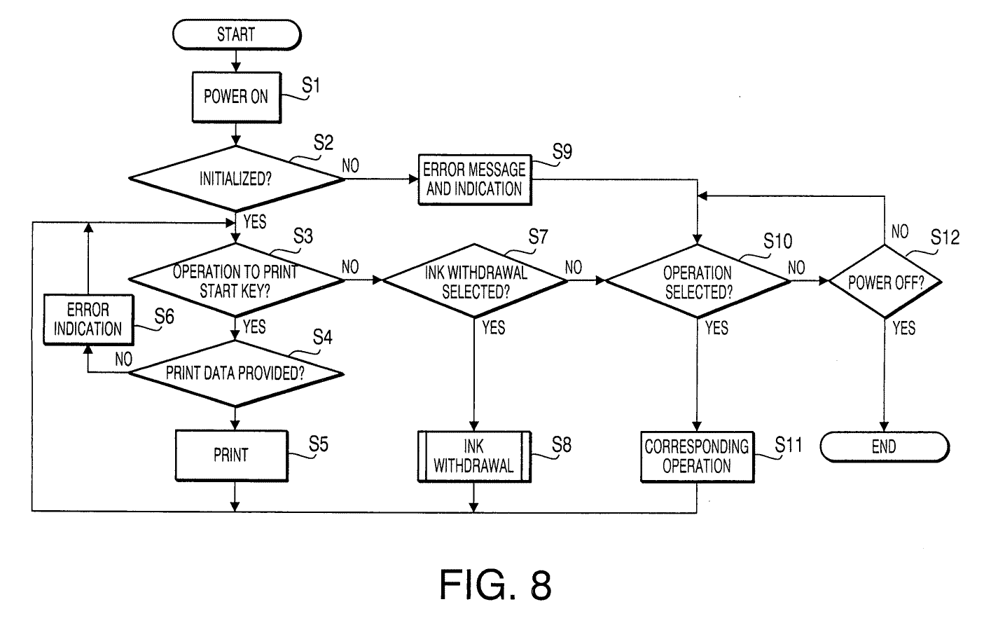

Next, a main flow of the operation of the inkjet printer 1 according to the embodiment of the present invention will be described with reference to FIG. 8. When the inkjet printer 1 is powered on by the operator and the operation starts in S1, the inkjet printer 1 is initialized. The initialization includes, for example, a flushing operation to prepare the nozzles of the first and the second recording heads 21, 22 in condition for ejecting ink drops. In S2, determination is made as to whether the initialization successfully completed. When the initialization fails (S2: NO), in S9, the error indicator 30b is activated. When the error indicator 30b is activated, for example, an indicator lamp is lit and/or an error indicating sound is generated.

Following S9, in S10, it is examined as to whether one of operation menus, which exclude “print,” “ink withdrawal,” and “head cleaning,” is selected. When one of the operation menus is selected (S10 YES), in S11, an operation corresponding to the selection is performed. Thereafter, the inkjet printer 1 waits for next input to select an operation menu.

In S10, if power to the inkjet printer 1 is shut off (S10: NO, S12: YES), the operation is terminated. If the power supply to the inkjet printer 1 is maintained (S12: NO), the process repeats S10.

In S2, when the initialization successfully completes (S2: YES), the inkjet printer 1 waits for selection of an operation menu to be entered. In S3, it is examined as to whether the print start key 29a has been operated. If the print start key 29a has been operated (S3: YES), in S4, it is examined as to whether the inkjet printer 1 is provided with print data. If no print data has been provided (S4: NO), in S6, an error is indicated, and the process returns to S3. If the inkjet printer 1 is provided with print data (S4: YES), in S5, a printing operation to print an image according to the print data is performed. The process returns to S3 thereafter.

In S3, if the print start key 29a has not been operated (S3: NO), in S7, it is examined as to whether an ink withdrawal operation is selected through a menu window displayed in the operation panel 28. If selection for the ink withdrawal operation is made (S7: YES), in S8, the ink remaining in the first ink conveyer tubes 34 is withdrawn in the first ink cartridges 31. The process returns to S3 thereafter. The ink withdrawal operation will be described later in detail.

Next, the ink withdrawal operation will be described with reference to FIG. 9. If the OK key 29f is pressed with the option “Ink Unloading” being selected, as shown in FIG. 7B, the ink withdrawal operation is started.

When the ink withdrawal operation starts, in S20, a message to indicate that the ink withdrawal is started is presented in the display 30. Next, in S21, it is examined, based on the input from the cartridge detective sensor 61, as to whether the first ink cartridges 31 are set to the housing portions of the first ink cartridge container 31a. If the first ink cartridges 31 are not set in the first ink cartridge container 31a (S21: NO), the error lamp 30b is lit, and in S30, an error message (e.g., “ink cartridges are not set”) is displayed on the display 30. Thereafter, the operation is terminated.

In S21, when the first ink cartridges 31 are set in the first ink cartridge container 31a (S21: YES), in S22, the air release valve 44 is switched to release the air flow in the ink conveyer tubes 34.

If the air release valve 44 is switched to release the air flow, in S23, a message (e.g., “Unloading . . . ”) to indicate that the ink is being withdrawn is presented in the display 30. The ink remaining in the first ink conveyer tubes 34 can be withdrawn and collected in the first ink cartridges 31 by utilizing the hydraulic head difference. Thereafter, in S24, it is examined again as to whether the first ink cartridges 31 are set in the housing portions of the first ink cartridge container 31a.

When the first ink cartridges 31 are not set in the predetermined positions of the housing portions (S24: NO), in S31, the air release valve 44 is switched to shut down the air flow in the first ink conveyer tubes 34. After switching the air release valve 44 to shut down the air flow, the error lamp 30b is lit, and in S32, an error message (e.g., “ink cartridge is not set”) is displayed in the display 30. Thereafter, the ink withdrawal operation is terminated. According to the above configuration, even when the first ink cartridges 31 are removed from the first ink cartridge container 31 a during the ink withdrawal, the ink being withdrawn is prevented from leaking out of the first ink conveyer tubes and around the inkjet printer 1.

When the first ink cartridge 31 is set in the first ink cartridge container 31a (S24: YES), in S25, it is examined, based on the input from the in-cartridge ink amount detective sensor 62, as to whether the amount of the ink in the first ink cartridges 31 reaches a predetermined level. In the present embodiment, the predetermined level refers to the full amount in the first ink cartridges 31.

Therefore, in S25, if the first ink cartridges 31 are filled with the ink (S25: YES), in S33, the air release valve 44 is switched to shut down the air flow in the first ink conveyer tubes 34. After switching the air release valve 44 to shut down the air flow, in S34, a message (e.g., “ink cartridge is full”) is displayed on the display 30. Thereafter, the ink withdrawal operation is terminated. According to the above configuration, even when the first ink cartridges 31 are filled with the ink to the full amount during the ink withdrawal, the ink being withdrawn is prevented from being overflowed from the first ink cartridge 31.

In S25, when the amount of the ink in the first ink cartridges 31 has not reached the predetermined level (S25: NO), in S26, it is examined, based on the input from the in-tube ink detective sensor 63, as to whether the ink remains in the first ink conveyer tubes 34.

In S26, if the ink does not remain in the first ink conveyer tubes 34 (S26: NO), in S35, the air release valve 44 is switched to shut down the air flow in the first ink conveyer tubes 34. After switching the air release valve 44 to shut down the air flow, in S36, a message (e.g., “no ink in the tubes”) is displayed in the display 30. Thereafter, the operation is terminated. Accordingly, when the remaining ink is cleared from the first ink conveyer tubes 34, the air release valve 44 is switched promptly to shut down the air flow in the first ink conveyer tubes 34, and the ink withdrawal operation is aborted; thus, operation efficiency of the inkjet printer 1 can be improved.

In S26, when the ink remains in the first ink conveyer tubes 34 (S26: YES), in S27, it is examined as to whether a predetermined time period, which is substantially long to withdraw the remaining ink from the first ink conveyer tubes 34, has elapsed. In this step, when the air release valve 44 is switched to release the air flow in the first ink conveyer tubes 34 in S22, the CPU 110 activates an inner timer. In S27, the CPU 110 compares the elapsed time of the inner timer activated in S22 with a predetermined period.

If the predetermined period has not elapsed (S27: NO), the process returns to S24. When the predetermined period elapses (S27: YES), in S28, the air release valve 44 is switched to shut down the air flow in the first ink conveyer tubes 34. Thus, because the air release valve 44 is switched to shut down the air flow in the first ink conveyer tubes 34 after the predetermined period, the inner surface of the ink conveyer tubes 34 is prevented from being exposed to open air so that even the minimum amount of ink remaining in the ink conveyer tubes 34 should not be dried out.

In S29, a message (e.g., “Ink withdrawn”) to indicate completion of the ink withdrawal is presented in the display 30. The operation is terminated thereafter.

According to the above operation, the ink remaining in the first the ink conveyer tubes 34 can be withdrawn and collected to be stored in the first ink cartridges 31 by utilizing the hydraulic head difference. Once the ink is collected, the ink can be stirred when the first ink cartridges 31 are removed from the inkjet printer 1 and shaken manually. When the first ink cartridges 31 containing the stirred ink are set again in the inkjet printer 1, the well-conditioned white ink can be ejected smoothly from the nozzles. Thus, the remaining ink, which may have been wasted in the conventional purging operation, can be prevented from being wasted. According to the above configuration, removal of the first ink conveyer tubes 34 in order to collect the remaining ink is not required, or branch structures to collect the remaining ink are not specifically required in the first ink conveyer tubes 34.

According to the above embodiment, the first ink conveyer tubes 34 can be switched between an open state and a closed state by the air release valve 44 provided in the first ink conveyer tubes 34. Therefore, by releasing the air flow in the first ink conveyer tubes 34 and utilizing the hydraulic head difference, the ink remaining in the first ink conveyer tubes 34 can be withdrawn therefrom to the first ink cartridges 31. Further, with the air release valve 44 in the open state, it is judged as to whether the ink can be withdrawn and collected in the first ink cartridges 31 in S24-S26. If it is judged that the ink should not be withdrawn, the ink withdrawal operation is terminated by shutting down the air flow in the first ink conveyer tubes 34.

According to the above embodiment, when the first ink cartridges 31 are not installed in the ink cartridge container 31a, the ink withdrawal operation to withdraw the ink to the first ink cartridges 31 is terminated; therefore, leakage of the reversed ink out of the disconnected first ink conveyer tubes 34 can be prevented.

According to the above embodiment, when the amount of the ink in the first ink cartridges 34 reaches the predetermined level, the ink withdrawal operation is terminated; therefore, overflow of the reversed ink out of the first ink cartridges 31 can be prevented.

According to the above embodiment, when the ink does not remain in the first ink conveyer tubes 34, the ink withdrawal operation is terminated; therefore, it can be prevented that the air flow in the first ink conveyer tubes 34 is maintained released even after the ink withdrawal completes. Accordingly, operation efficiency of the inkjet printer 1 can be improved.

According to the above embodiment, the optical sensors to detect the presence of the first ink cartridges 31 in the ink cartridge container 31a are provided inside the first ink cartridge container 31a; therefore, the optical sensors can be maintained without being exposed to the open air, and adherence of dust to the cartridge detective sensors 61 can be prevented.

According to the above embodiment, the optical sensors to detect the full amount of the ink in the first ink cartridges 34 are provided inside the first ink cartridge container 31a; therefore, the optical sensors can be maintained without being exposed to the open air, and adherence of dust to the in-cartridge ink amount detective sensors 62 can be prevented.

Although an example of carrying out the invention has been described, those skilled in the art will appreciate that there are numerous variations and permutations of the inkjet printing apparatus that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

For example, the in-cartridge ink amount detective sensor 62, which examines as to whether the ink in the first ink cartridge 31 reaches the predetermined level, may not necessarily be an optical sensor, but may be a weight sensor (e.g., a load cell) or a combination of the optical sensor and the weight sensor. With the weight sensor, the CPU 110 examines the amount of the ink in the first ink cartridges 31 based on that weight of the first ink cartridges 31 reaches a predetermined weight. If the weight of the first ink cartridges 31 reaches the predetermined weight, the air release valve 44 is switched to shut down the air flow in the first ink conveyer tubes 34.

With such a weight sensor, similarly with the optical sensor, the inkjet printer 1 can prevent the ink withdrawn from the first ink conveyer tube 34 from being overflowed out of the first ink cartridges 31. Further, with combination of the optical sensor and the weight sensor, the amount of ink in the first ink cartridge 31 can be even more reliably detected.

For another example, the predetermined level of the ink in the first ink cartridges 31 refers to the full amount to fill the first ink cartridges 31. However, the predetermined level may alternately be defined as a substantially operable amount. The in-cartridge ink amount detective sensor 62 is necessary to be located at an appropriate height corresponding to the definition of the predetermined level.

In the above embodiment, the in-tube ink detective sensors 63 are attached to the air release valve 44. However, it is even more preferable that the in-tube ink detective sensors 63 are fixed to portions in the vicinity of the first ink cartridges 31 by a fixing means.

In addition to the air release valve 44 in the first ink conveyer tubes 34 for white ink, air release valves in a similar configuration may be provided to the second ink conveyer tubes 35 for the CMYK inks.

Further, it is to be noted that the air releasing mechanism may be provided to other inks than the white ink, containing solid component which may be deposited in the ink, to prevent concentration gradient.

Furthermore, the present invention can be similarly applied to an inkjet printer which is capable of printing an image on a sheet of paper and other recording medium, in place of a piece of fabric, in inks. Moreover, the present invention can be effectively applied to an ink applying apparatus, which ejects, for example, ultraviolet curable ink or other ultraviolet curable agent (e.g., foundation coat and overcoat) to surfaces of an object.

What is claimed is:

1. An inkjet printing apparatus to form an image on a recording medium according to print data representing the image, comprising:
a recording head, which ejects ink onto the recording medium;
an ink cartridge, which contains the ink therein;
an ink cartridge storage to store the ink cartridge;
an ink conveyer tube, which connects the recording head and the ink cartridge to convey the ink;
a releasing system, which is arranged in the ink conveyer tube to switch an open state in which air flow in the ink conveyer tube is released and a closed state in which the air flow in the ink conveyer tube is shut down;
a release controller, which controls switching of the releasing system; and
a judging system, which judges as to whether the ink in the ink conveyer tube is capable of being withdrawn in the ink cartridge,
wherein the release controller switches the releasing system in the open state to be in the closed state when the judging system judges that the ink is incapable of being withdrawn in the ink cartridge.

2. The inkjet printing apparatus according to claim 1,
wherein the judging system includes a cartridge detective unit, which detects presence of the ink cartridge in the ink cartridge storage; and
wherein the judging system judges that the ink is incapable of being withdrawn in the ink cartridge when the cartridge detective unit detects absence of the ink cartridge in the cartridge detective unit.

3. The inkjet printing apparatus according to claim 2,
wherein the cartridge detective unit includes an optical sensor installed in the ink cartridge storage.

4. The inkjet printing apparatus according to of claim 1,
wherein the judging system includes an in-cartridge ink amount detective unit, which detects the ink in the ink cartridge filled to a predetermined level; and
wherein the judging system judges that the ink is incapable of being withdrawn in the ink cartridge when the in-cartridge ink amount detective unit detects the ink in the ink cartridge reaching the predetermined level.

5. The inkjet printing apparatus according to claim 4,
wherein the in-cartridge ink amount detective unit includes an optical sensor installed in the ink cartridge storage.

6. The inkjet printing apparatus according to claim 5,
wherein the in-cartridge ink amount detective unit further includes an ink amount detecting member, which is in a shape of rod and is swingable about a supporting member;
wherein the ink amount detecting member is set in the in-cartridge detective unit in a posture to have one end thereof in contact with an ink pack installed in the ink cartridge so that the ink amount detecting member swings about the supporting member according to changes of a volume of the ink in the ink pack, and the other end of the ink amount detecting member is detected by the optical sensor when the volume of the ink in the ink pack reaches a predetermined level.

7. The inkjet printing apparatus according to claim 4,
wherein the in-cartridge ink amount detective unit includes a weight sensor installed in the ink cartridge storage.

8. The inkjet printing apparatus according to claim 1,
wherein the judging system includes an in-tube ink detective unit, which detects the ink remaining in the ink conveyer tube; and
wherein the judging system judges that the ink is incapable of being withdrawn in the ink cartridge when the in-tube ink detective unit detects absence of the ink in the ink conveyer tube.
